(19) United States
(12) Patent Application Publication
(10) Pub. No.: US 2025/0349001 A1
(43) Pub. Date: Nov. 13, 2025

(54) COMPUTER-IMPLEMENTED DETERMINATION OF CELL CONFLUENCE

(71) Applicant: Takeda Vaccines, Inc., Cambridge, MA (US)

(72) Inventors: Kerstin Sahlmann, Singen (DE); Markus Engel, Singen (DE)

(73) Assignee: Takeda Vaccines, Inc., Cambridge, MA (US)

(21) Appl. No.: 18/997,360

(22) PCT Filed: Jul. 17, 2023
(86) PCT No.: PCT/US2023/027922

§ 371 Date: Jan. 21, 2025

(30) Foreign Application Priority Data
Jul. 22, 2022 (EP) 22186511.6

(51) Int. Cl. G06T 7/00; G06V 10/766; G06V 20/69

(52) U.S. Cl. CPC G06T 7/0012; G06V 10/766; G06V 20/698; G06T 2207/10056; G06T 2207/20021; G06T 2207/30024

(57) ABSTRACT

A computer-implemented method of determining confluence of a cell culture is provided. The method comprises receiving (S1), with a computing device (10), image data (200) indicative of an image (201) of at least a part of a container (50) comprising a cell culture (51), splitting (S2) the image data (200) into a plurality of chunks (202), wherein each chunk is associated with an image portion (203) of the image (201), classifying (S3) the plurality of chunks (202) into at least a first class (202a) and a second class of chunks (202b), the first class being representative of chunks (202a) associated with an image portion (203) including a cellular object and the second class being representative of chunks (202b) associated with an image portion (203) including cell-free area, and computing (S4) a confluence value based on determining, for at least a subset of chunks (202b) classified into the second class, a number of chunks having at least one neighboring chunk (202b) classified into the second class.

### CLAIM OF PRIORITY

This application claims priority to European Patent Application 22 186 511.6, filed on 22 Jul. 2022, which is incorporated by reference in its entirety.

### TECHNICAL FIELD

The present disclosure generally relates to the determination of confluence or confluency of cells of a cell culture. In particular, the present disclosure relates to a computer-implemented method of determining confluence of a cell culture based on processing image data. Further, the present disclosure relates to a computing device configured to carry out steps of the method, to a corresponding computer program, and to a non-transitory computer-readable medium storing such program. Moreover, the present disclosure relates to use of the aforementioned method and/or device in a cell-based assay, in particular in one or more of a plaque assay, a toxicity assay, and a pharmacological assay.

### TECHNICAL BACKGROUND

In many technical areas, including the pharmaceutical, life science and bio-tech area, cell cultures are utilized for various purposes. Usually, the cell cultures are cultivated under defined conditions in containers and subsequently used, for example for testing an effect of a sample substance on the cell culture based on adding the sample substance to the container in the frame or course of a cell-based assay.

A typical and non-limiting example of an application of such cell-based assay in the pharmaceutical area is quality control, for example in drug or vaccine production. Therein, usually the titer or virus activity of a sample substance containing virus material is determined by adding the sample substance to a container that includes a cell culture and by counting plaques or foci induced by the virus material in the cell culture. This type of cell-based assay is also referred to as immune-focus assay (IFA) or plaque assay.

Usually, when using cell cultures in cell-based assays, the entire surface of a container should preferably be covered by a homogenous layer, in particular a monolayer, of cells of the cell culture. However, growth or growth rates of cells can be different at different positions of a container surface or area, which can lead to one or more holes or hole spots in the cell layer. Alternatively or additionally, growth or growth rates of cells can be different for different containers or cell cultures.

To allow for an assessment of a quality of a cell layer or culture in a container and/or to allow for an intercomparison of cell cultures cultivated in different containers, the confluence or confluency of the respective cell culture or container is usually determined, which refers to the percentage or fraction of the surface of a container covered by adherent cells. Therein, the confluence is usually determined based on counting the number of cells and/or holes in a particular volume or area of the container using a microscope and a counting chamber device. This conventional approach or procedure of determining confluence, however, can be time-consuming, error-prone and subject to interpersonal variations in counting.

### SUMMARY

It may, therefore, be desirable to provide for an improved method and device for determining confluence of a cell culture or adherent cells of a cell culture.

This is achieved by the subject matter of the independent claims, wherein further embodiments are incorporated in the dependent claims and the following description.

Aspects of the present disclosure relate to a computer-implemented method of determining confluence of a cell culture, to a computing device configured to carry out such method, to a computer program, to a computer-readable medium, and to the use of the method and/or computing device in a cell-based assay, in particular in one or more of a plaque assay, a toxicity assay, and a pharmacological assay. Any disclosure presented hereinabove and hereinbelow with respect to one aspect of the present disclosure equally applies to any other aspect of the present disclosure.

According to an aspect of the present disclosure, there is provided a computer-implemented method of determining, computing, estimating and/or assessing confluence of a cell culture and/or confluence of adherent cells of a cell culture. Alternatively or additionally, the method according to the present disclosure may relate to a computer-implemented method of determining confluence of adherent cells of a cell culture in a container. Therein, one or more steps of the method, in particular all steps of the method, can be carried out by means of a computing device. This does not exclude manual steps, for example related to preparation of the container and/or the cell culture. Accordingly, the method described herein may refer to a computer-implemented, a computer-assisted and/or a computer-based method. The method comprises the following steps:
receiving and/or processing, with a computing device, image data indicative of an image of at least a part of a container comprising a cell culture;
splitting the image data into a plurality of chunks, wherein each chunk is associated with an image portion of the image;
classifying, with a classifier of the computing device, the plurality of chunks into at least a first class and a second class of chunks, the first class being representative of chunks associated with an image portion including a cellular object and the second class being representative of chunks associated with an image portion including cell-free area, a hole and/or a hole spot; and
computing a confluence value based on determining, for at least a subset of or all of the chunks classified into the second class, a number of chunks having at least one neighboring chunk classified into the second class.

The inventors of the present invention found that splitting the aforementioned computer-implemented method of determining confluence based on processing image data of a container with a cell culture can allow for an accurate, efficient, fast, objective and reliable determination or computation of the confluence for a container or corresponding cell culture, in particular when compared to manual counting cells per area or surface area. Specifically, the computer-implemented approach of determining confluence based on splitting the image data into chunks, classifying the chunks with a classifier and further analyzing neighboring chunks described herein can allow for a much faster determination, which is less error-prone and not subject to interpersonal variations, as can be the case in manual counting or with other known software-assisted approaches for determining confluence. Also, data integrity may be significantly improved using the computer-implemented approach described herein.

Further, the method disclosed herein may be of particular advantage for quality control in the production or manufacturing of vaccines. It should be noted, however, that the method and device described herein can be used to advantage in various technical fields or areas, including pharmaceutical, bio-tech and life science.

Generally, confluence or the confluence value, also referred to as confluency, can refer to or be defined as fraction or percentage of a surface of a container that is covered by adherent cells of a cell culture relative to a total area of the container. Therein, the surface of the container may typically refer to or denote a container surface that is at least partly surrounded by a container wall, such that the cell culture can be cultivated on the surface of the container. Unless stated otherwise, reference to a surface of the container or a container surface relates to the part or area of the container, where a cell culture can be grown or is cultivatable.

As noted hereinabove, growth or growth rates of cells cultivated in a container can vary locally within the container. This can result in one or more holes or hole spots in the cell culture or the corresponding layer of cells formed in the container. Such hole or hole spot is also referred to herein as cell-free area of the container or its surface Depending on the location of a hole in the container, a hole can be partly or completely surrounded by adherent cells or collections of adherent cells of the cell culture. Also, different holes formed in the cell culture can strongly vary in size and shape.

Accordingly, an ideal or optimum cell culture 100% confluence would cover, preferably in a monolayer of cells, the entire container surface that is usable for cell cultivation and would not comprise any hole within the cell layer. On the other hand, presence of one or more holes and/or cell-free area in the container leads to a confluence value below 100%. Accordingly, confluence can be a useful measure or quantity indicative of a quality and/or homogeneity of the cell culture in a container across the container surface. Also, cell cultures in different containers can be quantitatively and qualitatively inter-compared based on the confluence value.

In practice, however, a cell confluence above about 90% to about 95% may be considered over-grown. For instance, containers with a confluence value above such values may not be used in cell-based assays.

As used herein, the computing device may refer to and/or include a processing circuitry with one or more processors for data processing. It is emphasized that any reference to a singular computing device herein can include a plurality of computing devices, such as a server network or cloud computing system. In other words, the computing device according to the present disclosure can refer to a computing network or computing system including a plurality of inter-operating and/or communicatively coupled devices. For receiving and/or transmitting data, the computing device may optionally include one or more communication interfaces, such as one or more wireless or wired communication interfaces.

The classifier of the computing device may generally refer to an artificial intelligence based (AI-based) algorithm or module, which may be implemented in software and/or hardware in the computing device. As will be further described hereinbelow, the classifier may be trained or pretrained to provide the functionalities of the method of the present disclosure.

The image data of the at least one image of the at least part of the container can refer to the data of one or more images of the at least part of the container acquired and/or captured with one or more image sensors of one or more cameras. Generally, the image data may be at least two-dimensional image data. For example, the image data may refer to two-dimensional image data or pixel data including a plurality of data elements in a data matrix or two-dimensional grid, wherein each data element can be associated with two-dimensional spatial coordinates, one or more color values and/or one or more intensity values. Alternatively or in addition, three-dimensional or multi-dimensional image data, such as for example depth sensor data, point cloud data or the like, may be used to determine the confluence value of the cell culture in the at least part of the container.

Further, the image data may be associated with an image of a part or portion of the container. Alternatively, image data of one or more images of the entire container may be processed. The latter may further increase a quality and precision in the determination of the confluence. Alternatively or additionally, a plurality of containers may be captured in one or more images and the image data of these one or more images may be used to determine the confluence.

Further, as used herein, a chunk may refer to or denote a subset of data elements, for example a subset of pixel data, of the image data. Therein, the subset of data elements of the image data constituting a chunk can be associated with and/or be indicative of a part, piece or portion of the image of the at least part of the container. Optionally, each chunk may be associated with a particular position, for example a two-dimensional position, and/or area of the corresponding image portion in the image.

The first class and second class of chunks, and optionally one or more further classes, may generally refer to a grouping or classification of chunks according to at least one predefined classification criterion. For the first class, the at least one classification criterion can be defined as to whether the chunk or corresponding image portion under investigation contains at least one cellular object, for example a collection of adherent cells substantially covering the image portion associated with the chunk. For the second class, the at least one criterion may be defined as to whether the chunk or corresponding image portion under investigation contains, comprises and/or substantially consists of cell-free area, such as one or more holes and/or hole spots in the cell layer. Optionally, one or more further classification criteria for the first, the second and/or one or more further classes may be defined.

As used herein, the container may refer to a tank, vessel, well, flask, vial, culture dish or compartment of arbitrary geometry, shape, and/or volume, which is suitable and/or configured for containing or holding a cell culture. As noted above, the container may include a surface that may be at least partly surrounded by a container wall and configured to grow a cell culture thereon. Said surface of the container may also be referred to as usable surface of the container.

In particular, the container may refer to or include a well of a (standard) multi-well assay plate, preferably a 6-well plate, 12-well plate or 24-well plate. However, other types of containers, such as 48-well, 96-well, 384-well and 1536-well plates, may also be used. Such configuration may allow to determine the confluence values of wells, sequentially or simultaneously, based on analyzing the image data of one or more images of the plurality of wells. In turn, precision, quality, efficiency, and speed in the determination or computation of the confluence value can be further improved and/or increased.

The cell culture can generally include animal, plant, bacterial cells or cells of any other type of organism. Alternatively or additionally, the cell culture can include living cells, dead cells or a mixture thereof. Optionally, the cells or at least a part thereof may be stained to increase visibility.

As used herein, a cellular object may refer to or denote a part of a cell, such as a cell component or cellular constituent. Alternatively or additionally, a cellular object may refer to or denote an entire cell or a plurality of cells. In particular, a cellular object may refer to or denote an arrangement or collection of a plurality of adherent cells.

According to an embodiment, the plurality of chunks is classified based on a logistic regression classifier. For instance, a binary logistic regression model with two classes, such as at least the first class and second class of chunks, or a multi class logistic regression model more than two classes, such as at least the first class and second class of chunks and optionally the thirds class of chunks, can be utilized.

Generally, a logistic model can model the probability of an occurrence of an event, for example reflected or defined in the at least classification criterion for each class considered, based on representing the logarithmic odds for the event as linear combination of one or more independent variables. By means of logistic regression, the parameters of a logistic model, for example given by the one or more coefficients of the linear combination, may be determined.

Splitting the image data into a plurality of chunks and classifying the chunks based on logistic regression for subsequent analysis can allow for robust determination or detection of parts of the image that contain cell-free area or a hole within a short period of time. In particular, a number of false positives for erroneously detected or determined chunks of the second class can be significantly reduced by utilizing logistic regression, for example when compared to other AI-based algorithms, such as algorithms based on object detection or neural networks. Also, training efforts and an amount of training data may be reduced compared to other AI-based approaches.

According to an embodiment, the confluence value is determined based on determining a number of chunks having a predetermined or predefined minimum number of neighboring chunks classified into the second class. Therein, neighboring chunks may be associated with neighboring image portions. For instance, neighboring chunks may refer to or denote chunks associated with image portions, which are arranged next to each other, adjacent to each other and/or in juxtaposition in the image. Alternatively or additionally, neighboring chunks can refer to chunks surrounding a chunk under investigation in one or more spatial directions. Alternatively or additionally, neighboring image portions can refer to image portions surrounding an image portion of a chunk under investigation in one or more spatial directions. Further, neighboring chunks and/or the neighboring image portions may at least partly overlap each other or may directly adjoin each other.

Analyzing the chunks neighboring a particular chunk of the second class in terms of their classification can allow to reliably identify a hole or hole spot within the cell layer or cell culture, and for example discern such hole or hole spot from cells, which may be spaced apart from each other but otherwise adhere to each other. In other words, by analyzing the neighboring chunks in terms of their classification, true holes in the cell culture or cell layer can be reliably detected or determined. Also, since the holes or hole spots can vary in size and shape, an analysis of neighboring chunks in terms of their classification can allow for a precise estimation of the area of the hole and/or cell-free area. Alternatively or additionally, chunks, which have been erroneously classified into the second class as containing cell-free area can be reliably determined and optionally disregarded for the computation of the confluence. In turn, accuracy of the determined confluence can be improved.

According to an embodiment, the confluence value is determined based on iteratively determining, for each chunk of the at least subset of or all of the chunks classified into the second class, a number of neighboring chunks classified into the second class, wherein each neighboring chunk is associated with an image portion neighboring the image portion of said chunk. Therein, the one or more neighboring chunks may be arranged next to each iteratively analyzed chunk of the second class in one or more spatial directions.

In an exemplary implementation, determining the number of chunks of the second class having a predetermined or predefined minimum number of neighboring chunks classified into the second class may comprise determining, for each chunk of the at least subset of or all of the chunks of the second class, whether one or more neighboring chunks are classified into the second class. The method may further comprise counting the neighboring chunks to determine the number of neighboring chunks classified into the second class. Optionally, the determined number of neighboring chunks of the second class (also referred to as second class chunks) for a particular chunk considered may then be compared to the predetermined or predefined minimum number of neighboring chunks classified into the second class. This can allow for a reliable detection of cell-free area of any size and shape, and can allow to reliably detect chunks, which have been erroneously classified into the second class.

According to an embodiment, computing the confluence value comprises filtering chunks classified into the second class based on determining a predetermined minimum number of neighboring chunks being classified into the second class. For instance, chunks of the second class having a number of neighboring chunks of the second class below the predetermined minimum number may be considered as erroneous, since it may be assumed that the chunk under considerations does not code for or contain a true hole, but rather contains slightly spaced apart cells or collections of cells, which may have led to the erroneous classification into the second class.

According to an embodiment, computing the confluence value comprises identifying and/or flagging one or more chunks, which are classified into the second class and have less than a predetermined minimum number of neighboring chunks classified into the second class. Optionally, the method may further comprise disregarding the identified and/or flagged chunks in the computation of the confluence. Based on flagging the chunks, the respective chunks can be marked for removal from the second class of chunks to compute the confluence.

According to an embodiment, the predetermined minimum number is at least two, preferably at least three, even more preferably at least four. Accordingly, for each chunk of the second class or the at least subset thereof, it may be determined whether said chunk neighbors and/or is arranged next to at least two, three, four or even more neighboring chunks of the second class. The remaining chunks of the second class, i.e. the second class chunks having less neighboring chunks of the second class than the predetermined minimum number, may be disregarded in the computation of cell the free-area for computing the confluence, as these chunks may not code for or not comprise cell free area or a hole, but rather may contain a different structure, for example spaced apart cells or cell collections. It should be noted, though, that chunks flagged for removal from the computation of the confluence may only be disregarded for estimating the cell-free area, but they may be considered for computing the total area of the container. Also, it is noted that flagged chunks of the second class may optionally be re-classified to chunks of the first or another class.

According to an embodiment, computing the confluence value includes computing a total number of chunks of the first class and the second class. If more than two classes are considered, the total number of chunks may optionally include the number of chunks of all further classes. In an example, the confluence may be computed based on the ratio of chunks classified into the second class and the total number of chunks, into which the image data is split. Optionally, only the number of chunks of the second class, which neighbor and/or are arranged next to at least two, three, four or even more neighboring chunks of the second class, may be considered for computing the confluence, or more specifically for computing the hole area or total cell-free area. Again, it is noted that second class chunks having less than the predetermined number of neighboring chunks of the second class may be considered and taken into account for computing the total number of chunks.

According to an embodiment, the image data is indicative of an image of at least a part of a surface of the container, wherein the cells of the cell culture are distributed across at least a part of the surface of the container. Alternatively or additionally, the image portion associated with each chunk is indicative of a portion of a surface of the container. As noted above, the surface of the container may be at least partly surrounded along a perimeter by wall of the container to form a compartment in the container that can contain the cell culture. Accordingly, the surface of the container refers to or denotes an outer surface usable for cell cultivation.

According to an embodiment, splitting the image data into chunks comprises grouping pixel data of adjoining pixels of the image data. Alternatively or additionally, each chunk may define an area of adjoining pixels of the image. For example, groups of pixel data or groups of pixels may be selected, wherein each group of pixel data or pixels may constitute a chunk of the image data.

In an exemplary implementation, the image data can be split, such that different chunks are associated with different image portions of the image. In other words, each chunk may be associated with a particular image portion or part of the image. Accordingly, the chunks or corresponding image portions may be distributed across the image to substantially cover at least a part of or the entire image.

According to an embodiment, the image data is split, such that neighboring chunks are associated with non-overlapping and/or directly adjoining image portions of the image. Accordingly, the chunks may be chosen or selected such that the associated image portions do not overlap and/or are flush with each other. Avoiding overlapping chunks and image portions can allow to reduce the overall number of chunks, and thus can allow to increase performance.

According to an embodiment, the image data is split, such that the image portions associated with the plurality of chunks cover the entire image. Hence, the entire image or image information contained in the image data can be efficiently used or analyzed with a minimum number of chunks.

According to an embodiment, the image data is split into chunks associated with image portions of equal size, width, height and/or shape. Therein, each chunk may be associated with or define a group of pixel data or pixels of the image, which may constitute the image portion of said chunk. Generally, the image portions defined by the chunks may extend in at least two spatial dimensions or directions, in particular at least two orthogonal spatial directions. For instance, each image portion may have at least a width and a height. Such width and height of an image portion, or in general the size of the image portion, may in the context of the present disclosure also be referred to as width and height of the corresponding chunk, or generally the size of the chunk. Accordingly, a chunk size, chunk width, chunk height or other chunk dimension can be synonymously used herein with a size, width, height or other dimension of the image portion associated with said chunk.

Further, the image portions defined by the plurality of chunks may have an arbitrary geometrical shape or form, such as a round shape, a rectangular shape, an elliptical shape, a rounded shape, a polygonal shape, a triangular shape, a square shape or any other shape. Preferably, the shape and/or size of the image portions and/or the chunks should be selected such that a maximum overall area of the image can be covered by the plurality of chunks. Splitting the image data into chunks or image portions of equal size and/or shape can particularly allow to use substantially the entire image information or data for determining the confluence with a minimum number of chunks. In turn efficiency and performance in determining the confluence can be further increased.

According to an embodiment, the image data is split into chunks based on cropping the image into a plurality of image portions arranged in a plurality of rows and columns in the image. For example, for each chunk, the remaining image data or pixel data (i.e. the pixel data not constituting said chunk) can be removed from the image data by cropping these remaining parts of the image. The plurality of chunks or associated image portions may be arranged in a matrix structure in a plurality of rows and columns on the image. Accordingly, each chunk may be uniquely identifiable based on its column and row number.

According to an embodiment, each chunk is associated with an image portion of predefined size. In case of two-dimensional image data, images, chunks and/or associated image portions, each chunk may have a size and/or may be associated with an image portion having a size between about 250 px² to about 2000 px², in particular about 950 px² to about 1000 px², for example about 972 px². It should be noted, though, that the present disclosure is neither limited to two-dimensional image portions or chunks nor to a particular chunk size or size of the image portion.

According to an embodiment, the method further comprises determining a width and a height of the image, and determining one or more of a chunk width, a chunk height, and a chunk size based on the determined width and height of the image. In a non-limiting example, a width of the image may be between about 500 px to about 5000 px, for example about 2592 px, and a height of the image may be about 500 px to about 5000 px, for example about 1944 px. Any other size, width and/or height of the image is possible.

According to an embodiment, one or more of the chunk size, the chunk width and the chunk height is determined, such that one or more of the size, width and/or height of the image is divisible by the chunk size, width, and/or height. For instance, the width of the chunks may be selected, such that the width of the image is divisible by the chunk width. Alternatively or additionally, the height of the chunks can be determined such that the height of the image is divisible by the chunk height. This may allow to cover the entire image with the chunks, respectively, split the entire image into chunks, without losing image information.

According to an embodiment, each chunk has a rectangular size, and the image data is split into several rows and columns of chunks. Accordingly, the image or image data may be split in a matrix-like structure with a plurality of columns and rows of chunks. Therein, the chunks can be identified by the respective column and row indices or numbers.

According to an embodiment, the method further comprises converting the received image data into gray scale or binary image data. Converting the image data into gray scale can include converting RGB values of the image data into a single gray scale value. Accordingly, complexity and amount of data of the image data ca be reduced. Also, gray scale conversion can lead to a reduction of color features of the image, such as blue or yellow spots or image features, in comparison to the original image, which in turn can improve robustness of the classification into the first and second class as well as improve overall performance and robustness in the determination of the confluence value. Optionally, only a subset of RGB values, of the image data may be converted into gray scale. Alternatively or additionally, each element of an RGB value of the image data may be altered and/or converted into grayscale. Therein, an element of an RGB value may be referred to as one of three RGB channels. Alternatively or additionally, only one or two elements of each RGB value may be altered and/or converted into gray scale.

In an embodiment, the image data may be classified for each channel of RGB values separately. Optionally, the image data separately classified for each RGB channel may be combined to compute the confluence value. Alternatively or additionally, for each separately classified RGB channel, a single confluence value may be computed, and optionally the three confluence values for the three RGB channels may be combined.

According to an embodiment, the plurality of chunks is classified into at least three classes, the third class being representative of chunks associated with an image portion transitioning between a cellular object and cell-free area. Accordingly, the third class may represent or code for chunks or image portions covering the transition between chunks of the first class that code for or represent cellular objects and chunks of the second class that code for or represent cell free area. Alternatively or additionally, the third class may code for or represent structures or features in the image data, which can neither be classified into the first nor the second class.

According to an embodiment, the container is a well of a multi-well (standard) assay plate, preferably a 6-well plate or 12-well plate. Such configuration may allow to determine confluence based on one or more images capturing at least a portion of one or more wells of a multi-well plate. In particular, at least one image of at least a part of each well may be captured and processed to determine the confluence value for each well. Alternatively or additionally, an overall confluence value, for example a mean or average confluence, may be determined for a plurality of the wells of the multi-well plate.

According to an embodiment, receiving the image data includes retrieving the image data from one or more data sources, for example from one or more data storages of the computing device or any other data source. In other words, the computing device may comprise at least one data storage, and the computing device may be configured to retrieve the image data from the data storage of the computing device. Alternatively or additionally, the computing device may be configured to retrieve and/or receive the image data from an external data source communicatively coupled to the computing device, such as an external data source of a further computing device. Alternatively or additionally, the image data may be retrieved from one or more cameras.

According to an embodiment, receiving the image data comprises acquiring and/or capturing one or more images of the at least part of the container using at least one camera operatively coupled to the computing device. The one or more captured images may be stored on a data storage and retrieved therefrom by the computing device. Alternatively or additionally, the at least one camera may be configured to transmit the image data to the computing device, for example via wireless or wired connection. Optionally, a plurality of images of a single container may be captured from one or more view angles by one or more cameras, and the images or corresponding data may be combined to generate the image data.

According to an embodiment, receiving the image data comprises acquiring an image of the at least part of the container using at least one camera operatively coupled or couplable to the computing device. The at least one camera may include one or more optical or image sensors for capturing the image or image data. Alternatively or additionally, the at least one camera may refer to a microscope camera, which may allow to acquire cellular objects or structures at high magnification.

A further aspect of the present disclosure relates to the use of the method and/or the computing device as described hereinabove and hereinbelow in or for a cell-based assay.

Typically, cell-based assays may require a defined starting point for the assay. Therein, the starting point may, for example, be a cell culture or container having a predefined minimum confluence value. By means of the method and computing of the present disclosure, it may be ensured that only cell cultures and/or containers having at least the predefined confluence are used for the subsequent steps of the cell-based assay.

A further aspect of the present disclosure relates to the use of the method and/or the computing device as described hereinabove and hereinbelow in one or more of a plaque assay, a toxicity assay, and a pharmacological assay.

A further aspect of the present disclosure relates to a computer program, which when executed by one or more processors of a computing device, instructs the computing device to carry out steps of the method as described hereinabove and hereinbelow.

A further aspect of the present disclosure relates to a non-transitory computer-readable medium having stored thereon a computer program, which when executed by one or more processors of a computing device, instructs the computing device to carry out steps of the method as described hereinabove and hereinbelow.

A further aspect of the present disclosure relates to a computing device comprising one or more processors for data processing, wherein the computing device is configured to carry out steps of the method as described hereinabove and hereinbelow.

Any feature, function, step and/or element presented hereinabove and hereinbelow with reference to one aspect of the present disclosure equally applies to any other aspect of the present disclosure.

According to an embodiment, the computing device further comprises at least one interface configured to operatively and/or communicatively couple the computing device to at least one camera for acquiring and/or capturing one or more images of the container. The data of the one or more images may be used to generate the image data. Optionally, the computing device may further comprise at least one camera configured to acquire the image data and/or one or more images of the container.

In the following, illustrative examples and exemplary implementations of the present disclosure are summarized. In an optional preparation step, one or more containers, wells, and/or multi-well plates may be labelled with a unique identifier or code to allow for a parallel analysis and unique identification of the containers subsequently used to determine confluence. The one or more containers may be seeded with cells. A surface of each container, which should preferably be covered by a cell culture or a cell layer after cultivation of the cells, can range from about 2 cm² to about 20 cm². To seed containers with about 9.6 cm² container or surface area, a cell concentration of about 1.33E+0.5 cells/ml may be used, which may lead to about 3.99E+0.5 cells per well or container. Thus, per well or container with 9.6 cm² surface area, about 3 ml volume of seeding suspension may be used and the total volume for one 6-well plate may be about 18 ml. To counter-check the cell concentration, the Neubauer counting chamber can be used, wherein living and dead cells may be counted. Optionally, a dilution factor may be considered for calculating cell concentration.

One or more containers intended to be used for determining confluence can be prepared as follows. Cultivation media can be sucked, each container can be washed, e.g. with 2 ml of cold PBS, the washing media PBS can be sucked and the previous two steps can be repeated. Further, 1 ml methanol may be added at −20° C., and the containers can be incubated for one hour. The prepared containers can then be dried at room temperature.

In order to determine confluence, a classification and filtering technique can be applied, as described herein. In a first step, an image of at least a part of a container may be captured or acquired. An exemplary image can have a width (w) of about 2592 px and a height of about 1944 px. The image or image data may then be split into a plurality of chunks, for example based on cropping the image into smaller chunks with a width of about 36 px and a height of about 27 px. Optionally, the width and height of the chunks can be determined using the YOLO algorithm (‘You Only look Once’) or another algorithm for object recognition or detection. Generally, a chunk can be defined as a subpart of an image and may originate from altering the image or cropping it into several pieces. Chunks can also be named as tiles herein.

The chunks can then be classified into two or more classes. In an exemplary implementation, a logistic regression model can be used as classifier. The first class can be defined as all chunks, which contain one or more cellular objects. The second class can be defined as all chunks, which contain cell-free area, optionally without any border regions and/or without cellular objects. An optional third class be defined as all chunks, which cover the transition between chunks for cells and such coding for cell free area or holes.

A class model can be utilized in the logistic regression, which can consist of several functions, which can be called for different purposes, e.g. the fit function for training or the predict weights one, in which the user can define specific bias and weight values. To initialize a class object, one can hand over a learning rate (LR) as well as initial bias and weights, by default the LR is set to 0.000001, bias and weights to none. For setting own start values, it can be reasonable to use numbers close to zero for the initial weights setting and to adjust the bias in relation to the labeled data set.

For determining confluence, the second class of chunks may be of relevance. Chunks with cell free area, however, may be considered a statistically rare event. Related to the fact that the second class may code for holes or cell free area in an image, the assumption of finding a hole or cell free area in an image may be quite low in comparison to the expected quantity of cells in a container and thus the number of chunks of the first class. Related to the fact that the second class may be considered as a rare event and considering a high starting bias in comparison to the other one or more classes, false positive classifications may occur, in particular during training, which may lead to overestimation of the cell free area. To reduce the number of false positives, chunks erroneously classified into the second class can be identified and removed from further analysis, based on detecting, for each second class chunk, at least one, at least two, at least three, or at least four adjacent or neighboring chunks, which are also classified into the second class.

Here, the chunks may only fulfill the requirement that they are neighbor chunks without considering the neighboring direction, for example without considering if they are arranged in a column, row, diagonal or a mixture thereof. As discussed in more detail hereinabove, this approach allows to filter erroneously classified second class chunks and thus to increase accuracy of the determined confluence value.

All chunks of the second class, in particular after filtering, can be added up to gain the total number of all chunks, which are considered as holes or considered as containing cell free area. For the calculation itself, one image may code for 100%, which may relate to a particular fraction or percentage of each chunk with respect to the image size. For instance, each chunk may correspond to about 0.01% to about 1% of the total image area. In a non-limiting example, a chunk may correspond to about 0.0193% of the total image area. Hence, based on determining the total amount of chunks and the number of (optionally filtered) second class chunks, the confluence value can be computed.

As mentioned above, in typical cell cultures, the number of cells is much higher than the holes or cell free area. This means for the actual training of the classifier that the nature of the training data may lead to an unbalanced data set, which is a data set with a huge imbalance with respect to the classification criteria applied. Such unbalanced data sets can adversely affect predictions of logistic regression models. Therefore, the model can be balanced by creating pseudo images form existing ones based on randomly shifting coordinates of structures in the image data using random numbers. With the balanced data set, training of the multi class logistic regression model as well as inference can be further improved

These and other aspects of the disclosure will be apparent from and elucidated with reference to the appended figures, which may represent exemplary embodiments.

### BRIEF DESCRIPTION OF THE DRAWINGS

The subject-matter of the present disclosure will be explained in more detail in the following with reference to exemplary embodiments which are illustrated in the attached drawings, wherein:

FIG. 1 shows a computing device for determining confluence of a cell culture in a container according to an exemplary embodiment;

FIG. 2 shows a computing device for determining confluence of a cell culture in a container according to an exemplary embodiment;

FIG. 3 shows a cross-sectional view of a computing device according to an exemplary embodiment;

FIG. 4 shows evaluated image data illustrating steps of a method of determining confluence of a cell culture in a container according to an exemplary embodiment; and

FIG. 5 shows a flowchart illustrating steps of a method of determining confluence of a cell culture in a container according to an exemplary embodiment.

The figures are schematic only and not true to scale. In principle, identical or like parts are provided with identical or like reference symbols in the figures.

### DETAILED DESCRIPTION OF EXEMPLARY EMBODIMENTS

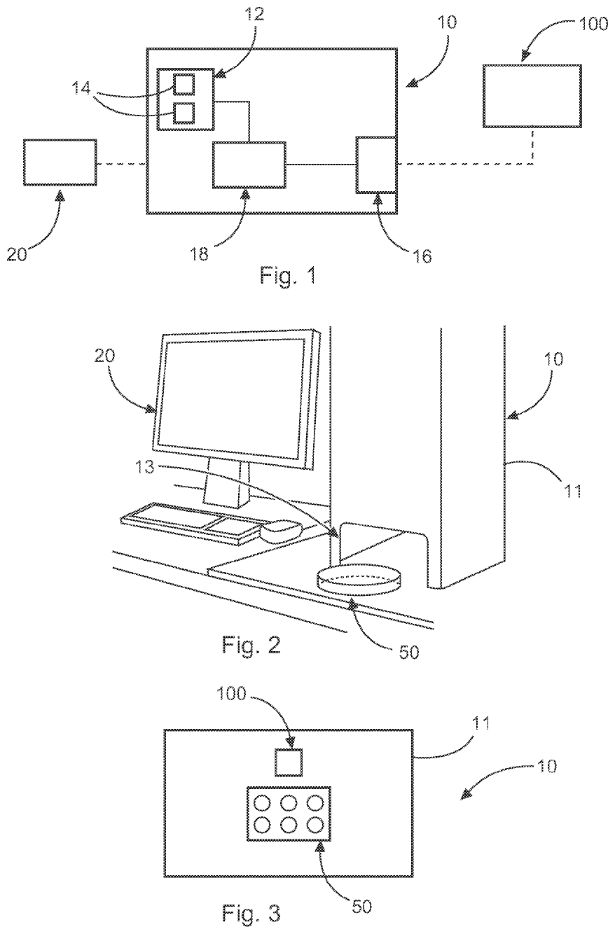

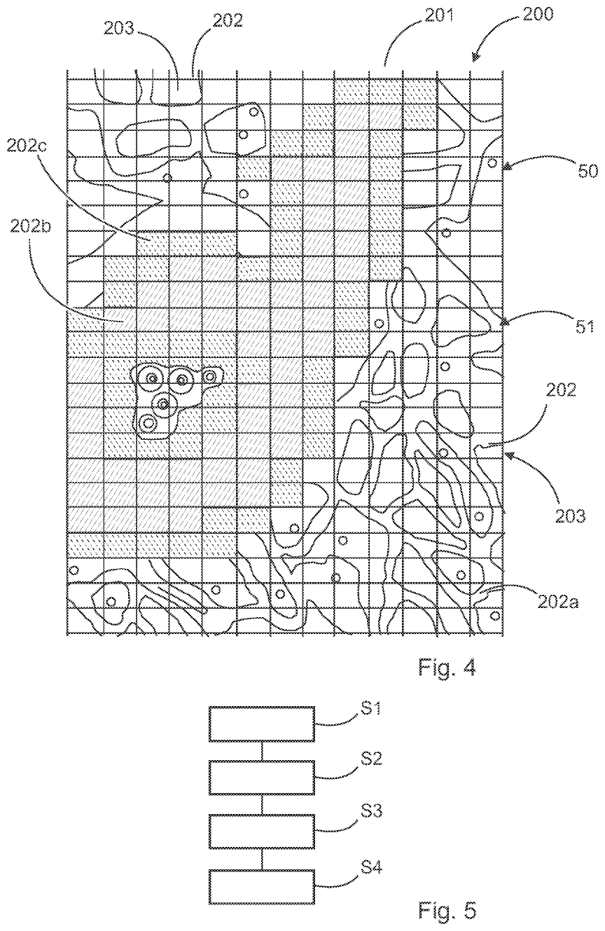

FIG. 1 shows a computing device 10 for determining confluence, a confluence value and/or confluency of adherent cells of a cell culture 51 (see FIG. 4) in a container 50 (see FIGS. 2, 3, 4) according to an exemplary embodiment.

The computing device 10 includes a processing circuitry 12 with one or more processors 14 for data processing. At least one classifier or classifier circuitry may be at least partly implemented in hard- and/or software in the processing circuitry 12 for determining the confluence value, as described in more detail hereinabove and hereinbelow. In particular, the classifier may be a logistic regression classifier, for example utilizing a binary or multi class logistic regression model.

The computing device 10 further includes at least one interface 16 for communicatively and/or operatively coupling at least one camera 100 to the computing device 10. Therein, the camera 100 may be considered as part of the computing device 10 or may be considered as external component. Via the interface 16, the camera 100 may be operationally controlled. For example, acquisition of one or more images may be triggered by the computing device 10. Alternatively or additionally, image data of one or more images may be received from the camera 100 via the interface 16. Generally, the camera 100 may be any suitable camera for acquiring images of the cell culture 51. In particular the camera 100 may be a microscope camera 100 and the acquired images may be microscopic images.

Optionally, the computing device 10 may be operatively and/or communicatively coupled to a microscope and/or a microscope camera 100. Alternatively or additionally, the computing device 10 may include a microscope and/or a microscope camera 100.

The interface 16 may be configured for wired or wireless communication using one or more communication protocols. Optionally, a plurality of cameras 100 may be coupled to the computing device 10.

The computing device 10 further includes a data storage 18 for storing at least the image data of the camera 100. The data storage 18 may also store software instructions for instructing or controlling the computing device 10 and/or the camera 100.

Further, the computing device 10 comprises a human machine interface 20, such as a monitor, allowing to present information to a user or operator and/or allowing to receive control signals therefrom to operationally control the computing device 10 and/or the camera 100.

FIG. 2 shows a computing device 10 for determining confluence, a confluence value and/or confluency of adherent cells of a cell culture 51 in a container 50 according to an exemplary embodiment. FIG. 3 shows a cross-sectional view of a computing device 10 according to an embodiment. Unless stated otherwise, the computing devices 10 of FIGS. 2 and 3 comprise the same features, functions and/or elements as the computing device 10 described with reference to FIG. 1.

The exemplary computing device 10 of FIGS. 2 and 3 comprises a housing 11 with a front opening 13 to insert one or more containers 50. In particular, the housing 11 and the front opening 13 may be sized and configured to receive at least a 6-well plate with six containers 50, as shown in FIG. 3. It is noted that in the example of FIG. 2 a single-well plate with a single container 50, respectively a single container 50, is illustrated, whereas in the example of FIG. 3 a 6-well plate with six containers 50 is illustrated. However, also in the embodiment of FIG. 2 a multi-well container 50 may be used and/or in the embodiment of FIG. 3 a single well container 50 may be used. Alternatively or additionally, 12- or 24-well plates or other containers can be used in either embodiment shown in FIGS. 2 and 3.

The housing 11 and front opening 13 may particularly serve to block light from outside during acquisition of the one or more images of the containers 50.

As schematically shown in the cross-sectional view of FIG. 3, the computing device 10 may comprise a plurality of cameras 100, wherein the cameras 100 may be arranged on different sides of the container 50 or multi-well plate 50 to acquire images from different viewing angles. For instance, one camera 100 may be arranged above the containers 50 and another camera 100 may be arranged on a side of the containers 50 or tilted with respect to a vertical direction. Other view angles and camera positions are possible.

To illustrate steps of a method of determining confluence of a cell culture 51 in a container 50 according to an exemplary embodiment, FIG. 4 shows evaluated image data 200 or an image 201 of at least a part of a container 50, which contains the cell culture 51 with a plurality of cells. It should be noted that the image data 200 shown in FIG. 4 may also refer to annotated image data 200 that can be used for training the classifier, for example the logistic regression classifier.

For determining the confluence of the cell culture 51, the image 201 or image data 200 shown in FIG. 4 is split into a plurality of chunks 202, each being associated with a particular image portion 203. The chunks 202 and associated image portions 203 are shown in the example of FIG. 4 as rectangular boxes of equal sizes, i.e. having identical widths and heights. Also, the image data 200 is split into chunks 202 or image portions 203, which are arranged in a matrix structure in a plurality of rows and columns to cover the entire image 201. Further, the chunks 202 and/or associated image portions 203 do not overlap with each other but are arranged flush with respect to each other. Other shapes, forms and arrangements of the chunks 202 are possible, as described hereinabove.

Subsequent to or simultaneously to splitting the image data 202 into the plurality of chunks 202, each chunk 202 may be associated with one of a plurality of classes. In particular, each chunk 202 may be classified into at least a first class of chunks 202a containing one or more cellular objects, and into at least a second class of chunks 202b containing cell free area and/or at least one hole. Optionally, and as shown in FIG. 4, at least one third class of chunks 202c may be considered, which may cover the transition between cellular objects and holes or cell free area. In the example of FIG. 4, the first class chunks are shown without hatching or as empty boxes, the second class chunks 202b are labelled with solid line hatching, and the third class chunks 202c are labelled with dashed line hatching.

To finally determine the confluence or confluence value, a number of chunks 202b is determined, which are classified into the second class and which have a predetermined minimum number of neighboring chunks 202b classified into the second class. As discussed in detail above, analyzing the neighboring chunks 202a, 202b, 202c of each second class chunk 202b can allow to detect erroneously classified second class chunks 202b to further improve accuracy and precision in the determination of the confluence.

For instance, the confluence value can be determined based on iteratively determining, for each chunk 202b classified into the second class, the number of neighboring chunks 202b classified into the second class, and by comparing the determined number of neighboring chunks 202b to a predetermined minimum number or threshold number of neighboring chunks 202b classified into the second class.

Optionally, erroneously classified second class chunks 202b can be filtered based on flagging one or more chunks 202b, which are classified into the second class and have less than the predetermined minimum number of neighboring chunks 202b classified into the second class. The flagged chunks 202b may then be disregarded for the computation of cell free area, and optionally re-classified into the firs or third class.

The predetermined minimum number of neighboring chunks 202b classified into the second class may, for example, be at least two, preferably at least three, even more preferably at least four neighboring chunks 202b classified into the second class.

Further optionally, the total number of chunks 202 of all classes may be determined, and the confluence may be computed based on the ratio of (optionally filtered) chunks 202b of the second class by the total number of chunks 202.

FIG. 5 shows a flowchart illustrating steps of a method of determining confluence of a cell culture 51 in a container 50 according to an exemplary embodiment, for example using a computing device 10 as described with reference to one or more of FIGS. 1 to 4.

In a first step S1 image data 200 indicative of an image 201 of at least a part of a container 50 comprising a cell culture 51 is received by the computing device 10. Optionally, one or more images 201 may be acquired with one or more cameras 100 in step S1. Further optionally, image data 200 of the one or more images 201 may be retrieved from a data storage 18 of the computing device 10 in step S1.

In a further step S2, the image data 201 is split into a plurality of chunks 202, wherein each chunk 202 is associated with an image portion 203 of the image 201.

Step S3 comprises classifying, with a classifier of the computing device 10, the plurality of chunks 202 into at least a first class of chunks 202a and a second class of chunks 202b, the first class being representative of chunks 202a associated with an image portion 203 including a cellular object and the second class being representative of chunks 202b associated with an image portion including cell-free area.

In a further step S4, a confluence value is determined based on determining, for at least a subset of or all of the chunks 202b classified into the second class, a number of chunks 202b having at least one neighboring chunk classified into the second class.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

As used herein, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

Furthermore, the terms first, second, third or (a), (b), (c) and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In the context of the present invention any numerical value indicated is typically associated with an interval of accuracy that the person skilled in the art will understand to still ensure the technical effect of the feature in question. As used herein, the deviation from the indicated numerical value is in the range of ±10%, and preferably of ±5%. The aforementioned deviation from the indicated numerical interval of ±10%, and preferably of ±5% is also indicated by the terms “about” and “approximately” used herein with respect to a numerical value.

What is claimed is:

1. A computer-implemented method of determining confluence of a cell culture, the method comprising:
receiving (S1), with a computing device (10), image data (200) indicative of an image (201) of at least a part of a container (50) comprising a cell culture (51);
splitting (S2) the image data (200) into a plurality of chunks (202), wherein each chunk is associated with an image portion (203) of the image (201);
classifying (S3), with a classifier of the computing device (10), the plurality of chunks (202) into at least a first class (202a) and a second class of chunks (202b), the first class being representative of chunks (202a) associated with an image portion (203) including a cellular object and the second class being representative of chunks (202b) associated with an image portion (203) including cell-free area; and
computing (S4) a confluence value based on determining, for at least a subset of chunks (202b) classified into the second class, a number of chunks having at least one neighboring chunk (202b) classified into the second class.

2. The method according to claim 1, wherein the plurality of chunks (202) is classified based on a logistic regression classifier using a binary or multi class logistic regression model.

3. The method according to claim 1, wherein the confluence value is determined based on determining a number of chunks (202b) classified into the second class and having a predetermined minimum number of neighboring chunks (202b) classified into the second class.

4. wherein the confluence value is determined based on iteratively determining, for each chunk of the at least subset of chunks (202b) classified into the second class, a number of neighboring chunks (202b) classified into the second class, wherein each neighboring chunk is associated with an image portion (203) neighboring the image portion of said chunk.

5. The method according to claim 4, further comprising:
comparing the determined number of neighboring chunks (202b) to a predetermined minimum number of neighboring chunks classified into the second class.

6. The method according to claim 3, wherein the predetermined minimum number is at least two, preferably at least three, even more preferably at least four.

7. The method according to claim 1, wherein computing the confluence value includes computing a total number of chunks (202, 202a, 202b) of the first class and the second class.

8. The method according to claim 1,
wherein splitting the image data (200) into chunks (202) comprises grouping pixel data of adjoining pixels of the image data; and/or
wherein each chunk (202) defines an area of adjoining pixels of the image (201).

9. The method according to claim 1, wherein the image data (200) is split, such that different chunks (202) are associated with different image portions (203) of the image (201); and/or wherein the image data (200) is split, such that neighboring chunks (202) are associated with non-overlapping and/or directly adjoining image portions (203) of the image (201).

10. The method according to claim 1, wherein the image data (200) is split, such that the image portions (203) associated with the plurality of chunks (202) cover the entire image (201).

11. The method according to claim 1, wherein the image data (200) is split into chunks (202) associated with image portions of equal size and/or shape.

12. The method according to claim 1, further comprising:
determining a width and a height of the image (201); and
determining one or more of a chunk width, a chunk height, and a chunk size based on the
determined width and height of the image.

13. The method according to claim 12, wherein the chunk size is determined, such that the width and/or height of the image is divisible by the chunk width and/or chunk.

14. The method according to claim 1, wherein the plurality of chunks (202) is classified into at least three classes, the third class being representative of chunks associated with an image portion transitioning between a cellular object and cell-free area.

15. Use of the method according to claim 1 in a cell-based assay, in particular in one or more of a plaque assay, a toxicity assay, and a pharmacological assay.
